(19) United States
(12) Patent Application Publication
(10) Pub. No.: US 2009/0319987 A1
(43) Pub. Date: Dec. 24, 2009

(54) Automatic Fixed Point Code Generation

(76) Inventor: Christopher T. Bartz, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/142,195

(22) Filed: Jun. 19, 2008

(51) Int. Cl. G06F 9/44

(52) U.S. Cl. 717/109

(57) ABSTRACT

Automatically generating optimized code for a fixed point application. A graphical program may be stored, where the graphical program includes a plurality of interconnected nodes which visually indicate functionality of the graphical program, and where the graphical program includes fixed point data types. A portion of the graphical program may be analyzed. The portion of the graphical program may include one or more fixed input values, one or more fixed point output values, and one or more nodes which perform an operation. Code may be automatically generated based on the analysis. The code may be executable to perform the operation using the one or more fixed point input values and to produce the one or more output values. The automatically generated code may improve run time behavior of the portion of the graphical program.

### FIELD OF THE INVENTION

The present invention relates to the field of fixed point programming, and more particularly to a system and method for automatically generating code for performing operations in a fixed point program.

### DESCRIPTION OF THE RELATED ART

In recent years, fixed point programming has become more important, e.g., when deploying and/or designing systems which do not include floating point processing capabilities. The fixed point programmer may use graphical programming methods (such as those provided by National Instruments Corp.) or textual programming methods.

Some systems allow for the propagation of attributes (e.g., wordlength) throughout the program (e.g., in graphical programs). However, in creating fixed point programs, or programs which include fixed point values and/or calculations, a typical fixed point programmer may still have to keep track of the word lengths or other attributes in order to ensure proper calculation methods (e.g., by manually coding or modifying various arithmetic functions), handling of overflow possibilities, keeping track of the binary point (e.g., where floating point calculations are not possible), sign extension, computation of double word intermediate results, and/or other difficult or tedious tasks.

Accordingly, improvements in fixed point programming methods are desired.

### SUMMARY OF THE INVENTION

Various embodiments of a system and method for automatically generating code for performing operations in a fixed point program.

A graphical program may be stored. The graphical program may include a plurality of interconnected nodes which visually indicate functionality of the graphical program. Additionally, the graphical program may include fixed point data types.

A portion of the graphical program may be analyzed. The portion of the graphical program may include one or more fixed point inputs and/or one or more fixed point outputs and one or more nodes which perform an operation. In one embodiment, the portion of the graphical program may include the one or more fixed point inputs and the one or more fixed point outputs. The operation may be a basic arithmetic operation.

Code may be automatically generated based on the analysis. The automatically generated code may be executable to perform the operation at runtime using the one or more fixed point inputs and/or may produce the one or more fixed point outputs. In some embodiments, the automatically generated code may be textual code or graphical code, as desired. Additionally, or alternatively, the automatically generated code may be platform independent.

In one embodiment, the automatically generated code may include one or more replaceable functions. Correspondingly, lower level code may be specified (e.g., manually by a user, or automatically without user input specifying the lower level code). The lower level code may be platform dependent (e.g., assembly code).

The automatic generation of code described above may improve run time behavior of the portion of the graphical program.

Finally, the graphical program may be deployed on a device (e.g., an embedded device), where the device does not include a floating point processor.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system operable to execute a graphical program according to an embodiment of the present invention;

FIG. 1B illustrates a network system comprising two or more computer systems that may implement an embodiment of the present invention;

FIG. 2A illustrates an instrumentation control system according to one embodiment of the invention;

FIG. 2B illustrates an industrial automation system according to one embodiment of the invention;

FIG. 3 is a flowchart diagram illustrating one embodiment of a method for generating code for a fixed point program; and

FIG. 4 is an exemplary graphical program portion usable in the method of FIG. 3, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference:

The following references are hereby incorporated by reference in their entirety as though fully and completely set forth herein:

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment”.

U.S. Pat. No. 6,173,438 titled “Embedded Graphical Programming System” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. Patent Application Publication No. 20010020291 (Ser. No. 09/745,023) titled “System and Method for Programmatically Generating a Graphical Program in Response to Program Information,” filed Dec. 20, 2000.

U.S. Patent Application Publication No. 2008/0034345 (Ser. No. 11/462,551) titled “A System and Method for Enabling a Graphical Program to Propagate Attributes of Inputs and Outputs of Blocks,” filed Aug. 4, 2006.

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as signals such as electrical, electromagnetic, or digital signals, conveyed via a physical communication medium such as a bus, network and/or other physical transmission medium.

Programmable Hardware Element—includes various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”.

Medium—includes one or more of a memory medium and/or a programmable hardware element; encompasses various types of mediums that can either store program instructions/data structures or can be configured with a hardware configuration program. For example, a medium that is “configured to perform a function or implement a software object” may be 1) a memory medium or carrier medium that stores program instructions, such that the program instructions are executable by a processor to perform the function or implement the software object; 2) a medium carrying signals that are involved with performing the function or implementing the software object; and/or 3) a programmable hardware element configured with a hardware configuration program to perform the function or implement the software object.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Graphical User Interface Element—an element of a graphical user interface, such as for providing input or displaying output. Exemplary graphical user interface elements comprise input controls and output indicators

Input Control—a graphical user interface element for providing user input to a program. An input control displays the value input the by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

Input/Output Attribute—Some attribute or characteristic of the data type of an input or output parameter. For example, the number of bits required to store data of a given type.

Data Type—Describes how information (bits) in storage (memory) should be interpreted. For example, the data type ‘double’ commonly means a 64-bit floating-point number in IEEE 754 format.

Representation—With regards to numbers, how numbers are represented in storage. For example the text ‘−12’ is decimal representation of the number negative twelve. In a 5 bit two's complement binary representation, ‘−12’ is expressed as ‘101100’.

Fixed Point Representation—a representation for fixed point numbers. Fixed point representations typically include various attributes, such as signed or unsigned, binary word length (the number of binary digits in the number), integer word length (the number of binary digits that represent the integer part of the word), and fractional word length (the number of binary digits that represent the fractional part). Thus, the word length is the integer word length+the fractional word length. Accordingly, only two of the attributes may need to be defined or kept track of.

The following provides one example for representing fixed point numbers. If there is an unsigned fixed point number with a word length of 5 bits, integer word length of 2 bits, and a fractional word length of 3 bits, ‘10100’ would represent 2.5. One notation for this number is +,5,2<10100> to indicate it is unsigned, 5 bit word length, and 2 bit integer word length (fractional word length can be derived from this). As another example, a signed version could be +/−,5,2 <10100> which represents −1.5.

Saturation—coercion of an output value to the output type's maximum if the output value is greater than the output type's maximum or coercion to the output type's minimum if the output value is less than the output type's minimum.

Wrap—the removal or discarding of a value's most significant bits in order to produce an output that is within the output type's range.

Quantization or Rounding—occurs when a value has greater precision than the output type. In such cases, the output value's precision is reduced. Quantization has several different modes including truncate (discarding the least significant bits to reach the proper precision), round-to-nearest (rounding value to the closest value within the output precision or up if the value is exactly half way between two valid output values, also referred to as round half up), and convergent rounding (same as round-to-nearest except rounds to the even value when the input is exactly half way between two valid output values, also referred to as round-to-nearest-even or round half even).

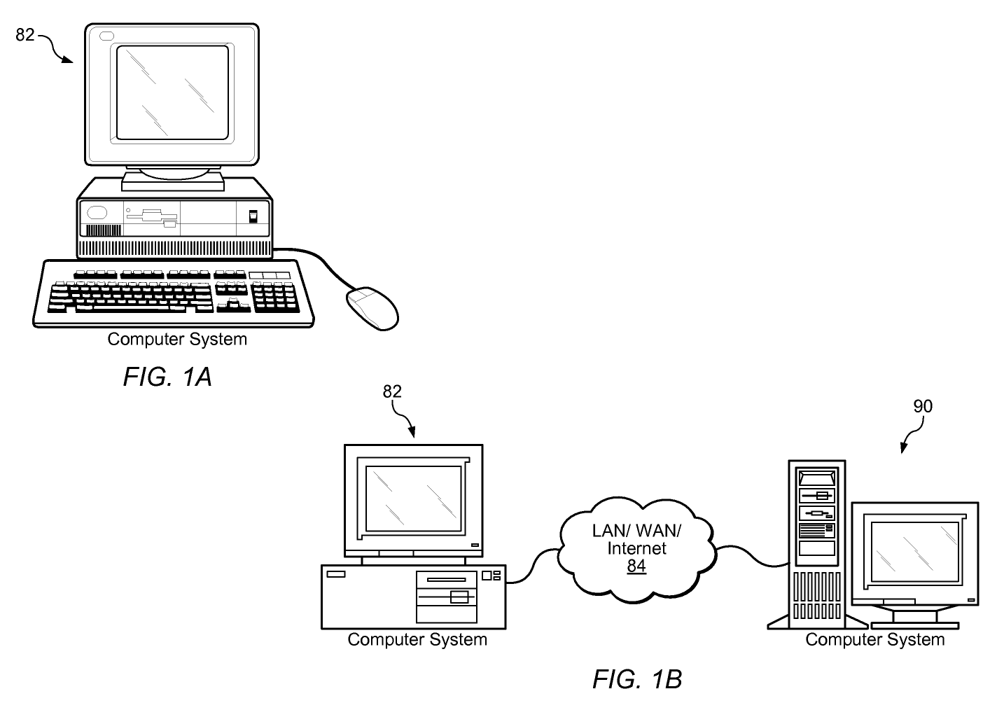

### FIG. 1A—Computer System

FIG. 1A illustrates a computer system 82 operable to execute a fixed point program. As used herein the term “fixed point program” may refer to a textual fixed point program (i.e., a fixed point program written in a textual computer language such as C) or may refer to a graphical program which includes or is executable to perform one or more fixed point operations). One embodiment of a method for automatically creating code for performing fixed point operations is described below.

As shown in FIG. 1A, the computer system 82 may include a display device operable to display the fixed point program (e.g., the graphical program) as the program is created and/or executed. The display device may also be operable to display a graphical user interface or front panel of the program during execution of the program. The graphical user interface may comprise any type of graphical user interface, e.g., depending on the computing platform.

The computer system 82 may include at least one memory medium on which one or more computer programs or software components according to one embodiment of the present invention may be stored. For example, the memory medium may store one or more programs which are executable to perform the methods described herein. Additionally, the memory medium may store a programming development environment application (e.g., a graphical programming development environment) used to create and/or execute such fixed point programs. The memory medium may also store operating system software, as well as other software for operation of the computer system. Various embodiments further include receiving or storing instructions and/or data implemented in accordance with the foregoing description upon a carrier medium.

### FIG. 1B—Computer Network

FIG. 1B illustrates a system including a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a fixed point program in a distributed fashion. As indicated above, in some embodiments, the fixed point program may be a graphical program. In other words, the graphical program may execute to perform one or more fixed point operations and may include fixed point inputs and outputs. In one embodiment, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program.

In one embodiment, the graphical user interface of the graphical program may be displayed on a display device of the computer system 82, and the block diagram may execute on a device coupled to the computer system 82. The device may include a programmable hardware element and/or may include a processor and memory medium which may execute a real time operating system. In one embodiment, the graphical program may be downloaded and executed on the device. For example, an application development environment with which the graphical program is associated may provide support for downloading a graphical program for execution on the device in a real time system. Similarly, a non graphical fixed point program may be deployed on various devices, executed in a distributed fashion, etc.

### Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the fixed point program (e.g., the graphical program) may be used include hardware-in-the-loop testing and rapid control prototyping, among others.

However, it is noted that the present invention can be used for a plethora of applications and is not limited to the above applications. In other words, applications discussed in the present description are exemplary only, and the present invention may be used in any of various types of systems. Thus, the system and method of the present invention is operable to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

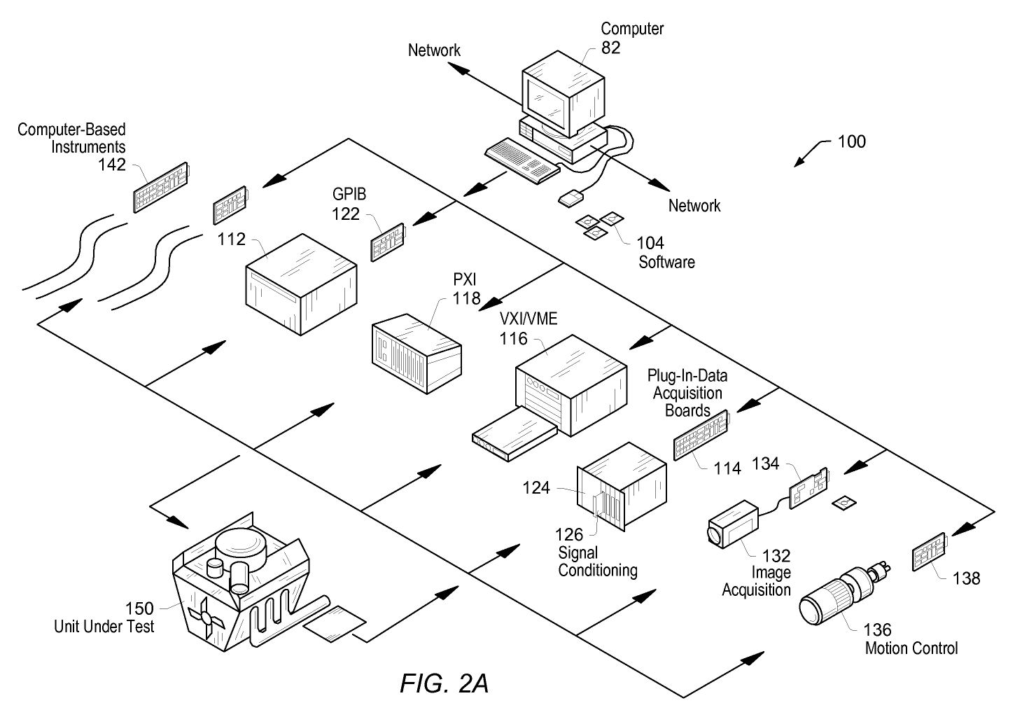

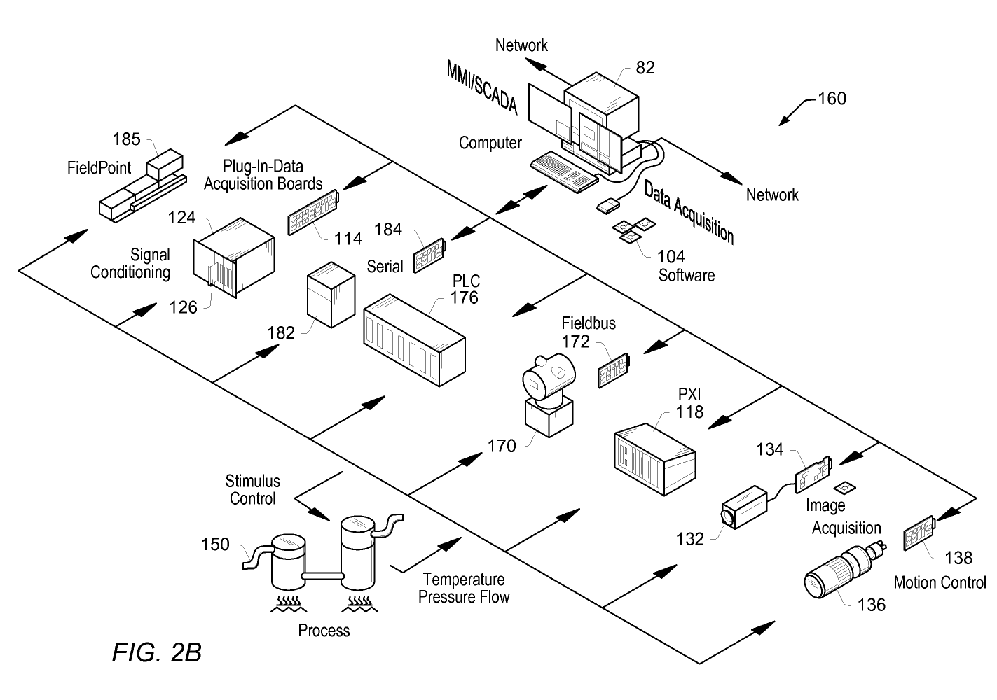

FIG. 2A illustrates an exemplary instrumentation control system 100 which may implement embodiments of the invention. The system 100 comprises a host computer 82 which couples to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to the unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application, among others.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which couples to one or more devices or instruments. The computer 82 may comprise a CPU, a display screen, memory, and one or more input devices such as a mouse or keyboard as shown. The computer 82 may operate with the one or more devices to a process or device 150 to perform an automation function, such as MMI (Man Machine Interface), SCADA (Supervisory Control and Data Acquisition), portable or distributed data acquisition, process control, advanced analysis, or other control, among others.

The one or more devices may include a data acquisition board 114 inserted into or otherwise coupled with chassis 124 with associated signal conditioning circuitry 126, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

In the embodiments of FIGS. 2A and 2B above, one or more of the various devices may couple to each other over a network, such as the Internet. In one embodiment, the user operates to select a target device from a plurality of possible target devices for programming or configuration using a graphical program. Thus the user may create a fixed point program on a computer and use (execute) the fixed point program on that computer or deploy the fixed point program to a target device (for remote execution on the target device) that is remotely located from the computer and coupled to the computer through a network.

Graphical software programs which perform data acquisition, analysis and/or presentation, e.g., for measurement, instrumentation control, industrial automation, modeling, or simulation, such as in the applications shown in FIGS. 2A and 2B, may be referred to as virtual instruments.

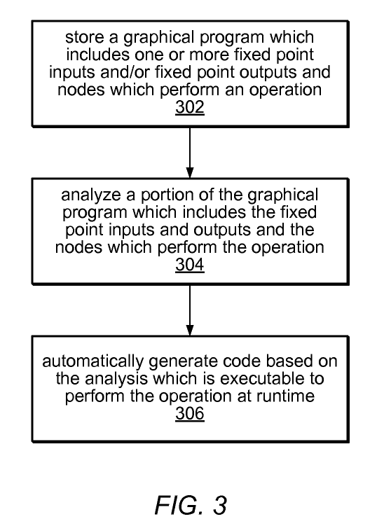

### FIG. 3—Method for Automatically Creating Fixed Point Code

In the exemplary embodiment shown in FIG. 3, FIG. 3 illustrates a method for automatically creating fixed point code. The method shown in FIG. 3 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 302, a graphical program may be stored. The graphical program may include a plurality of interconnected nodes which visually indicate functionality of the graphical program. The graphical program may include fixed point data types. A fixed point data type variable may store a value as well as information about the binary point location and type information (e.g., scalar, array, etc.). The fixed point data type variable may also store information regarding encoding, word length, range, and/or delta information (e.g., the maximum distance between any two sequential numbers in the set), among other possibilities. Fixed point information may be propagated as described in U.S. Patent Application Publication No. 2008/0034345 which was incorporated by reference above in its entirety. Note that various properties of the fixed point variable may be specified by the user (e.g., range, word length, encoding, etc.).

Additionally, the graphical program may include one or more nodes which perform an operation. The operation may be a basic arithmetic operation or a more advanced operation, as desired. For example, the operation may be a multiply, add, subtract, divide, increment, decrement, negative, equal, greater than, less than, not equal, logical shift, scale, rotate left and right, various conversions (e.g., to decimal, hexadecimal, octal, fractional, exponential, engineering, etc.), etc. However, other operations are envisioned, e.g., quotient and remainder, reciprocal, rotate, array operations (compound, add, multiply, etc.), format, scan, square root, maximum and minimum, in range and coerce, etc. As one specific example, the one or more nodes that perform the operation may include an arithmetic node (e.g., an add node) that has two input nodes (e.g., scalar nodes) coupled to the inputs of the arithmetic node and an output node (e.g., an output scalar node) coupled to the output of the arithmetic node. Thus, these plurality of nodes are executable to perform an arithmetic operation.

In some embodiments, the graphical program may be created manually or automatically, as desired. For example, various nodes may be included in the graphical program via a variety of methods. For example, the graphical program may be created or assembled by the user arranging on a display a plurality of nodes or icons and then interconnecting the nodes to create the graphical program. In response to the user assembling the graphical program, data structures may be created and stored which represent the graphical program. The nodes may be interconnected in one or more of a data flow, control flow, or execution flow format. The graphical program may thus comprise a plurality of interconnected nodes or icons which visually indicates the functionality of the program. As noted above, the graphical program may comprise a block diagram and may also include a user interface portion or front panel portion. Where the graphical program includes a user interface portion, the user may optionally assemble the user interface on the display. As one example, the user may use the LabVIEW™ graphical programming development environment to create the graphical program.

It should be noted that the graphical program may be created via alternative methods, e.g., automatic methods. For example, in an alternate embodiment, the graphical program may be created by the user creating or specifying a prototype, followed by automatic or programmatic creation of the graphical program from the prototype. This functionality is described in U.S. patent application Ser. No. 09/587,682 titled “System and Method for Automatically Generating a Graphical Program to Perform an Image Processing Algorithm”, which is hereby incorporated by reference in its entirety as though fully and completely set forth herein. Alternatively, the graphical program may be created in other manners, either by the user or automatically, as desired. The graphical program may implement a measurement function that may be performed by the instrument.

In one embodiment, the user may define the graphical program using a wizard or scripting tool, e.g., one that allows the user to iteratively describe the graphical program. In some embodiments, the wizard may include a series of graphical windows which asks the user to specify attributes of the graphical program. Correspondingly, the graphical program may be automatically generated from input received to the GUI, e.g., via the wizard. Thus, via various embodiments, the graphical program may be created or stored.

In 304, a portion of the graphical program may be analyzed. The portion of the graphical program may include the one or more fixed point inputs and/or one or more fixed point outputs. In other words, the graphical program portion may receive fixed point variables as input(s) and/or produce fixed point variables as output(s). The portion of the graphical program may also include the one or more nodes which perform the operation. Analysis of the portion of the graphical program may include analyzing the specific word lengths and attributes of the fixed point inputs and/or outputs as well as analysis of the operation being performed by the one or more nodes.

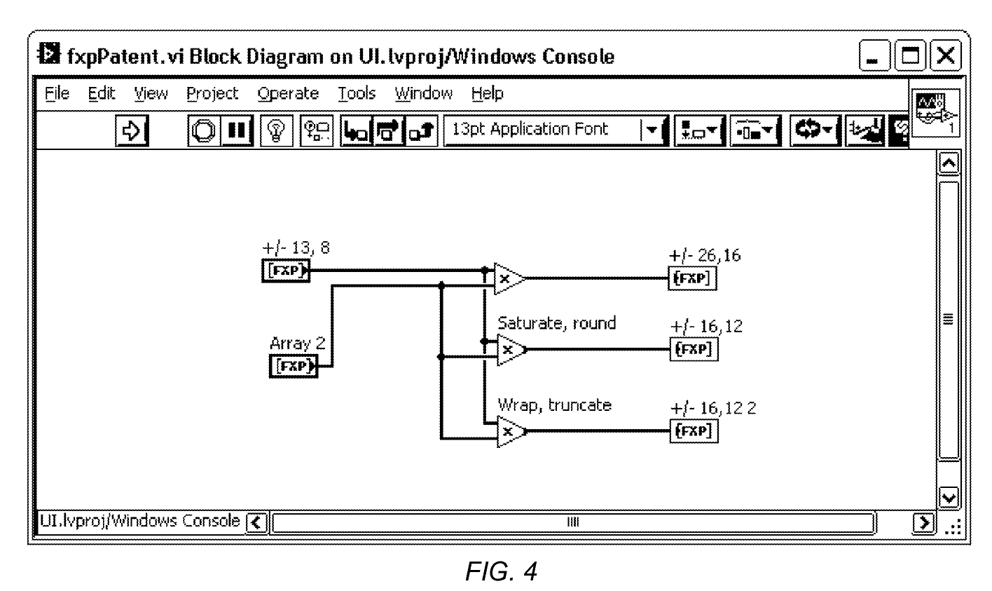

In 306, code may be automatically generated based on the analysis of 304. The automatically generated code may be executable to perform the operation at runtime using the one or more fixed point inputs and/or to produce the one or more fixed point outputs. The automatically generated code may improve the run time behavior of that portion of the graphical program, e.g., based on the particular data size of the inputs or outputs of the graphical program portion. For example, the automatically generated code may minimize the size of integers to hold data of the operation, based on the analysis in 304. Specific examples of automatically generated code and the corresponding graphical program portions are described below with respect to FIG. 4. As used herein, the term “automatic” refers to actions performed by the computer, e.g., in response to user input, but which the user does not actually perform. For example, in the case of 306 above, the automatic generation of code may be triggered by the user selecting a compile or execute button or completing specification of the graphical program portion, but the user does not manually enter the code that is automatically generated. Thus, the development environment or another computer program may execute to automatically generate the code for the user as opposed to the user manually typing the code out by hand.

Note that the automatically generated code may only perform integer operations. For example, the fixed point values may be stored in variables of type ‘integer’ in C or various other languages (such as an assembly language). Accordingly, integer math may be used to perform the operations. In one embodiment, for arrays and clusters of fixed point numbers, a type table may be used which may store the various used types and each fixed point type may be added to this table. Thus, the table may indicate the word length, the integer word length, and the actual size of the integer that is being used to store the data. So an fxp number that is 10 bits with 3 integer bits may be stored in a 16 bit number as that is the smallest sized C data type that will hold it. For scalars, this information may not need to be stored at runtime as it is known when the code is generated. Thus, in this case, the generated code may operate on the number correctly given its size and integer word length.

In some embodiments, the code may be additionally generated based on one or more options set by the user. For example, the user may be able to specify a global maximum word length (e.g., 64 bits, 32 bits, 16 bits, etc.). The maximum word length may be based on the processing capability of the target device (e.g., if the target device includes a non-floating point 32 bit processor, a 32 bit compiler, a 32 bit operating system, etc.). Alternatively, the user may simply specify the target device, and the maximum word length may be automatically determined. Thus, the automatically generated code may be generated based on the maximum world length set by the user. As a specific example, the automatically generated code may limit bit widths to 32 bits rather than typical 64 bit widths (word lengths) due to the constraints set by the user. In some embodiments, it may be possible for the user to set a maximum word length to a number greater than the maximum of a target. For example, 64 bits may be supported even on computers that have 32 bit integers, e.g., to give larger range and precision.

The user may also affect how the code is automatically generated by setting other options. For example, the user may be able to override the normal output word length, overflow handling, and quantization mode, e.g., for specific operations.

In some embodiments, the automatically generated code may be textual code, such as C or assembly language. The automatically generated code may be platform independent (e.g., so that it may be used in any system or processor architecture). However, it is also envisioned that the automatically generated code may be platform dependent, e.g., depending on the target to which the graphical program (or portion thereof) is to be deployed.

In some embodiments, the automatically generated code may include one or more replaceable functions. The user may manually replace these one or more replaceable functions with other code (e.g., assembly code that is platform or processor dependent, or more efficient code based on the user's knowledge) or the replaceable functions may be replaced automatically. For example, the user may specify a target for deploying the graphical program, and the replaceable functions may be replaced with code (e.g., assembly code) that is specific to the target on which the graphical program (or portion thereof) is to be deployed. This may be performed automatically (i.e., without the user manually specifying the replaceable code). For example, the user may simply specify a target for the graphical program, and the development environment (and/or other software) may determine the appropriate code (e.g., based on the platform of the target) and replace code in the automatically generated code with appropriate platform dependent code (e.g., lower level code, such as assembly code). However, it should be noted that this may be performed in the first place instead of replacing code in the automatically generated code. In other words, the user may specify a target, and the code may be automatically generated based on the specified target and on the analysis of 304.

In some embodiments, the user may be able to specify replacement code for a particular operation (e.g., add) and the replacement code may be propagated for every instance of the add operation, thus requiring the user to enter the replacement code only once. However, the user may be able to specify certain ones for replacement or certain ones for non-replacement, as desired.

As indicated above, the method may further include deploying the automatically generated code on a device. In some embodiments, the device may not include a floating point processor, in which case the automatically generated code may be especially important (e.g., because the target device may not be able to handle floating point operations, and accordingly, the automatically generated code may handle various cases (e.g., overflow, rounding, integer math which keeps track of the floating point, etc) that the target device could not have otherwise dealt with).

### FIG. 4—Exemplary Graphical Program Portion

The exemplary graphical program portion of FIG. 4 illustrates three different multiply operations. In the first one (410), the output data type is large enough (in total word length, integer word length, and fractional word length) that it cannot overflow or be rounded so a simple integer multiplication can be used in this case. The following represents exemplary automatically generated code corresponding to this example:

Boolean FXP_OpFunc_2(sFixedPoint32* fxpOut, sFixedPoint16* fxpIn1, sFixedPoint16* fxpIn2)
{

*fxpOut = *fxpIn1 * *fxpIp2;
return 1;

}

In the second (420), the result is specified as being smaller (e.g., by the user). For example, the result may need to be smaller than the intermediate result due to the maximum word length of a specified target or a specified value, e.g., specified by the user. Accordingly, the result may be saturated and/or rounded. The following represents exemplary automatically generated code corresponding to this example:

Boolean FXP_OpFunc_1(sFixedPoint16* fxpOut, sFixedPoint16* fxpIn1, sFixedPoint16* fxpIn2)
{

{

fxp_dwInt fxpMultTemp;
Boolean neg = (fxp_long_int) *fxpIn1 < 0;
neg = neg ? (fxp_long_int) *fxpIn2 > 0 : (fxp_long_int) *fxpIn2 < 0;
FXP_SW_UMULT(fxpMultTemp, (fxp_long_int) *fxpIn1 < 0 ? -((fxp_long_int) *fxpIn1) :

*fxpIn1, (fxp_long_int) *fxpIn2 < 0 ? -((fxp_long_int) *fxpIn2) : *fxpIn2);

if(neg) {

FXP_DW_NEGATE(fxpMultTemp);

}
{

FXP_DW_ROUND_CONVERGENT(fxpMultTemp, 0, 0x20, 0, 0x20, 0, 0x3f, 0xffffffff,

0xffffffc0, 0, 0x40);

{

Boolean saturate = false;
FXP_DW_SSAT_MAX(*fxpOut, fxpMultTemp, 0, 0x1fffc0, 0x7fff, saturate);
if(!saturate) {

FXP_DW_SSAT_MIN(*fxpOut, fxpMultTemp, 0xffffffff, 0xffe00000,

| | |
|---|---|
| 0xffff8000, | saturate); |

}
if(!saturate) {

FXP_DW_SHIFT_R_SHORT(*fxpOut, fxpMultTemp, 6, 26);
*fxpOut = FXP_SIGN_EXTEND(*fxpOut, 0x8000, 0xffff, 15);

}

}

}

}
return 1;

}

In the third example, it could overflow but saturation or rounding may not be performed, so there may be less work to do. The following represents exemplary automatically generated code corresponding to this example:

Boolean FXP_OpFunc_0(sFixedPoint16* fxpOut, sFixedPoint16* fxpIn1, sFixedPoint16* fxpIn2)
{

{

fxp_dwInt fxpMultTemp;
Boolean neg = (fxp_long_int) *fxpIn1 < 0;
neg = neg ? (fxp_long_int) *fxpIp2 > 0 : (fxp_long_int) *fxpIn2 < 0;
FXP_SW_UMULT(fxpMultTemp, (fxp_long_int) *fxpIn1 < 0 ? -((fxp_long_int) *fxpIn1) :

*fxpIn1, (fxp_long_int) *fxpIn2 < 0 ? -((fxp_long_int) *fxpIn2) : *fxpIn2);

if(neg) {

FXP_DW_NEGATE(fxpMultTemp);

}
{

FXP_DW_WRAP(fxpMultTemp, 0, 0x3fffc0);
FXP_DW_SHIFT_R_SHORT(*fxpOut, fxpMultTemp, 6, 26);
*fxpOut = FXP_SIGN_EXTEND(*fxpOut, 0x8000, 0xffff, 15);

}

}
return 1;

}

Note that there are more possibilities. For example, if the result is unsigned a sign extend may not be necessary. Additionally, if all operands are unsigned, it may not be necessary to check for negative inputs. Depending on how big the result is versus the “intermediate result”, different shifts may be used to get the data into the correct bits. These types of decisions may be different for different operations.

Note that the term “intermediate result” above refers to the full precision result of the operation before any rounding or saturating. This intermediate result may or may not be actually calculated, but it is useful as a reference, e.g., in discussing whether this intermediate result needs to be truncated, rounded, wrapped, saturated, etc.

Appendix I illustrates a helper file that contains a C implementation of the macros the automatically generated code may use. Note that this is exemplary only and is not intended to limit the scope of the automatically generated code described above.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for generating optimized code for a fixed point application, comprising:
storing a graphical program, wherein the graphical program comprises a plurality of interconnected nodes which visually indicate functionality of the graphical program, and wherein the graphical program comprises fixed point data types;
analyzing a portion of the graphical program, wherein the portion of the graphical program comprises one or more fixed point inputs and/or one or more fixed point outputs and one or more nodes which perform an operation;
automatically generating code based on said analyzing, wherein the automatically generated code is executable to perform the operation at runtime using the one or more fixed point inputs and/or to produce the one or more fixed point outputs;
wherein said automatically generating the code improves run time behavior of the portion of the graphical program.

2. The method of claim 1, wherein the one or more fixed point inputs and/or the one or more fixed point outputs comprise the one or more fixed point inputs and the one or more fixed point outputs.

3. The method of claim 1, wherein the automatically generated code is textual code.

4. The method of claim 1, wherein the automatically generated code is platform independent.

5. The method of claim 1, wherein the automatically generated code comprises one or more replaceable functions, and wherein the method further comprises:
specifying lower level code for the one or more replaceable functions, wherein the lower level code is dependent on a platform.

6. The method of claim 5, wherein said specifying the lower level code is performed automatically.

7. The method of claim 1, wherein the operation comprises a basic arithmetic operation.

8. The method of claim 1, further comprising:
deploying the automatically generated code on a device, wherein the device does not comprise a floating point processor.

9. A computer accessible memory medium storing program instructions for generating optimized code for a fixed point application, wherein the program instructions are executable by a processor to:
store a graphical program, wherein the graphical program comprises a plurality of interconnected nodes which visually indicate functionality of the graphical program, and wherein the graphical program comprises fixed point data types;
analyze a portion of the graphical program, wherein the portion of the graphical program comprises one or more fixed point input values, one or more fixed point output values, and one or more nodes which perform an operation;
automatically generate code based on said analyzing, wherein the automatically generated code is executable to perform the operation at runtime using the one or more fixed point input values and to produce the one or more fixed point output values;
wherein said automatically generating the code improves run time behavior of the portion of the graphical program.

10. The memory medium of claim 9, wherein the automatically generated code is textual code.

11. The memory medium of claim 9, wherein the automatically generated code is platform independent.

12. The memory medium of claim 9, wherein the automatically generated code comprises one or more replaceable functions, and wherein the program instructions are further executable to:
store lower level code for the one or more replaceable functions, wherein the lower level code is dependent on a platform.

13. The memory medium of claim 12, wherein the program instructions are further executable to specify the lower level code automatically.

14. The memory medium of claim 9, wherein the operation comprises a basic arithmetic operation.

15. The memory medium of claim 9, wherein the program instructions are further executable to:
deploy the graphical program on a device, wherein the device does not comprise a floating point processor.

16. A system, comprising:
a processor; and
a memory medium coupled to the processor, wherein the memory medium stores program instructions for generating optimized code for a fixed point application, wherein the program instructions are executable by the processor to:
store a graphical program, wherein the graphical program comprises a plurality of interconnected nodes which visually indicate functionality of the graphical program, and wherein the graphical program comprises fixed point data types;
analyze a portion of the graphical program, wherein the portion of the graphical program comprises one or more fixed point inputs and/or one or more fixed point outputs and one or more nodes which perform an operation;
automatically generate code based on said analyzing, wherein the automatically generated code is executable to perform the operation at runtime using the one or more fixed point inputs and/or to produce the one or more fixed point outputs;
wherein said automatically generating the code improves run time behavior of the portion of the graphical program.

17. The system of claim 16, wherein the automatically generated code is textual code.

18. The system of claim 16, wherein the automatically generated code is platform independent.

19. The system of claim 16, wherein the automatically generated code comprises one or more replaceable functions, and wherein the program instructions are executable to:
store lower level code for the one or more replaceable functions, wherein the lower level code is dependent on a platform.

20. The system of claim 16, wherein the program instructions are further executable to:
deploy the graphical program on a device, wherein the device does not comprise a floating point processor.
